(19) United States
(12) Patent Application Publication
(10) Pub. No.: US 2012/0144642 A1
(43) Pub. Date: Jun. 14, 2012

(54) Generating and Detecting Acoustic Resonance in Thin Films

(76) Inventors: Robert Steinkraus, San Francisco, CA (US); Abner F. Bello, Pleasanton, CA (US)

(21) Appl. No.: 12/965,769

(22) Filed: Dec. 10, 2010

(51) Int. Cl. G01N 29/04; G01N 29/00

(52) U.S. Cl. 29/407.01; 73/579

(57) ABSTRACT

A method and apparatus for film thickness measurements by inducing and detecting acoustic resonance in a sample is disclosed. Acoustic resonance is induced by generating acoustic waves using heterodyned laser beams to frequency-tune a periodic waveform; the detection is done by monitoring changes in a continuous wave, constant intensity laser probe beam. The laser beams and optical system are fiber-optic based.

### CROSS-REFERENCE TO RELATED APPLICATIONS

All references in the accompanying Information Disclosure Statement are incorporated herein in their entirety by reference.

### FIELD OF THE INVENTION

This invention relates to an apparatus for measuring the properties of thin films. More specifically to a system that generates a periodic waveform incident on a thin film, and detecting a reflected signal that is different when the period of the generated waveform corresponds to the acoustic resonance of the film.

### BACKGROUND OF THE INVENTION

A fast, non-destructive method of measuring thin film properties is of interest in the manufacturing process of electronic, optical, and mechanical devices that employ thin films. In one technique using thermal waves and described in several patents, for example U.S. Pat. No. 4,522,510, U.S. Pat. No. 4,513,385, U.S. Pat. No. 4,679,946 and prior art, for example, A. Rosencwaig et. al.; Applied Physics Letters 43 (2), 166, 1983; A. Rosencwaig et al.; Applied Physics Letters 46 (11), 1013, 1985, a periodic intensity, laser beam is focused onto a thin film; previous references are incorporated herein in their entirety by reference. Absorption of the periodic laser beam results in periodic heating and thus periodic expansion of the thin film. With a detection laser beam parallel and non-coaxial to the original beam also focused on the thin film, the periodic expansion induces a periodic change in the angle of deflection of the detection laser beam. The change in deflection is measured by a detector. The detector outputs this change in electrical signals that are displayed and recorded on an oscilloscope or computer. Various physical properties including thermal properties such as thermal conductivity, thermal expansion coefficient and volume specific heat can be correlated to the amount of change in the angle deflection. Other properties or parameters such as the thickness of the film or the amount of alteration done by the implantation of a different atomic species into the film can also be correlated. Deviation from the actual thermal properties or the given thickness can arise from defects like voids, cracks, delamination, and the presence of foreign particles. Surface roughness, voiding and imperfect crystalline structure are other characteristics that can affect the periodic signal. The periodic heating, called thermal waves, usually employs a periodic signal in the kilohertz to megahertz range. One could use this method for a fast, non-contact, small-spot method of determining thickness measurements. This technique requires continuous calibration, however, because in applications it cannot distinguish whether the signal is from changes in thickness or in the thermal properties. In addition, it cannot measure the individual thicknesses in a film structure with two or more layers.

There are variations to this thermal technique such as in U.S. Pat. No. 6,812,047 where structures of line array of films are measured instead of a blanket thickness. In U.S. Pat. No. 5,206,710 and U.S. Pat. No. 5,408,327 where the periodicity of heating is changed or where one laser beam instead of two is used; the concept is essentially identical. The prior art all measure the periodicity of thermal waves; all suffer the inability to measure two or more layers in physical contact.

Another technique involves the optical generation and detection of stress pulses as disclosed in U.S. Pat. No. 4,710,030, U.S. Pat. No. 5,706,094, U.S. Pat. No. 5,748,317; and G. Eesley et al., Applied Physics Letters 50 (12), 717, 1987, C. Thomsen et al., Physical Review Letters B 34(6), 4129, 1986), using short laser pulses; all incorporated herein in their entirety by reference. In a typical “pump-and-probe configuration”, a short laser pulse incident on the film surface gives rise to energy absorption, which induces thermal expansion. This thermal expansion results in the generation of a stress pulse in the surface of the film material that propagates through the film towards the substrate. At the interface with the substrate the pulse is reflected and propagates back toward the surface where it creates a change in reflectivity of the probe laser pulse. The time difference between the pump, generation of the stress pulse and the probe detection of the surface is the round trip travel time of the stress pulse through the layer(s) of interest. Knowing the stress pulse velocity in the material and this time difference between pump and probe leads to the distance it traveled or the film thickness. The probe reflectivity is continuously recorded as the time difference between it and the pump pulse scanned. Detection of the stress pulse is shown as changes in the reflectivity, where multiple round-trips can be observed as periodic instances of reflectivity changes. The use of short laser pulses, however, requires a high peak power that can sometimes alter or melt the material, especially if the film is on top of a highly insulating film.

In yet another technique using lasers and induced stress in the film, as disclosed in U.S. Pat. No. 5,633,711, U.S. Pat. No. 6,016,202 and J. A. Rogers et al., Journal of Applied Physics 75(3), 1534, 1994), all are incorporated herein in their entirety by reference, phonons, as of acoustic waves, are produced by time-coincident laser pulses intersecting at the sample surface, setting up an optical interference pattern, i.e., alternating intensity peaks and nulls. Energy absorption at the film results in the generation of counter propagating acoustic waves whose wavelength and orientation match the interference pattern. Thermal expansion at the peaks propagates towards the nulls, setting up the counter propagating acoustic waves. The waves can be described as a transient grating since it has the geometry of a grating and it is transient in that it propagates about the surface. A probe beam incident on the surface is reflected onto a detector, but the creation of the transient grating in the surface diffracts it in time and according to the rate of the counter propagating acoustic waves. The rate of propagation is correlated to the film thickness and the film thermal properties. Similar to the thermal wave technique, two or more film layers cannot be measured. The signal is also highly dependent on the substrate; a layer thinner than 300 Å in thickness is difficult to measure with this technique. In all the aforementioned techniques, the optical system is completely free-space based, that is, no fiber optics are used.

In another technique X-rays are used to measure the thickness and other properties like the density and roughness of thin films. In x-ray reflectivity (XRR), incident x-rays coming in at a small angle with the surface is reflected onto a detector. Scanning the angle results in a detected signal that has peaks and valleys according to the interference pattern resulting from reflections off the film surface and substrate. Fitting this data to a known model calculates the thickness, roughness, and density. This technique is accurate but slow and samples a large spot size.

In x-ray fluorescence (XRF), x-rays excite the electron state of atoms in the film, causing it to emit the element's characteristic x-ray energy as the electron relaxes from its excited state. The intensity of the emitted x-rays, the x-ray fluorescence, is proportional to the amount of the particular element and thus the thickness in the film. This technique requires calibration between the XRF intensity and the physical thickness. The spot size is also large. And similar to XRR, the use of x-rays requires shielding for safety.

Ellipsometry and reflectometry are two optically-based techniques in wide use in many applications. Their use, however, are limited to semiconductors and insulators because the light has to penetrate through the film and changes in polarization and intensity are measured. The polarization and intensity changes are used to calculate the thickness measurement. Light with wavelengths in the visible region does not penetrate metals, so ellipsometry cannot be used to measure metal films. Other systems for measuring the thickness of metal, semiconductor and insulator films are destructive techniques, that is, the measurement requires mechanical contact with the film which is undesirable.

### SUMMARY OF INVENTION

A method and apparatus for film property measurements by inducing and detecting acoustic resonance in a sample is disclosed. Resonance is induced by generating acoustic waves using heterodyned laser beams to frequency-tune a periodic waveform; the detection is done by monitoring changes in a continuous wave, non-pulsed, constant intensity laser probe beam reflected from a sample surface. The laser beams and optical system are fiber-optic based. Further analysis of reflectivity scan signals leads to other film properties such as density, ion implantation dose, and thermal conductivity. Multiple film layer thicknesses in a structure can be calculated; film thicknesses from about 1 nm to about 10 microns, single film or multiple, may be measured by the instant invention.

It is an object of this invention to provide a system for measuring physical characteristics and properties of a film. The system comprises means for generating an acoustic wave, optionally resonant, and means for detecting changes in the film's reflectivity arising from the acoustic wave. It is a further object of this invention that the system comprises fiber optics for the generation and detection of the acoustic wave. It is a further object of this invention that the system does not come into mechanical contact with the film it is measuring. It is a further object of this invention to provide such a system where a pump laser and a probe laser are required. It is a further object of this invention to provide such a system where the pump and probe beams are derived from independent sources. It is a further object of this invention to provide such a system where the probe laser beam has substantially constant intensity.

In one embodiment of this invention, a test sample being measured is physically distant, from about 0.001 meters to 10,000 meters away from the primary electronics and optical components, whereby fiber optics enables transmission of pump and probe beams to and from a sample. Fiber optic cables and/or connections may be used to transmit required pump and probe signals in and out of a processing chamber; such a chamber may be a semiconductor tool such as a vapor deposition chamber for physical or chemical depositions or ion implant or others; other industrial chambers are possible also.

In embodiments of this invention, the number of measurement sites may vary from 1 to more than 100; a system may be configured to measure all simultaneously, or sequentially or randomly, by employing by multiple fiber optic probes as disclosed in the instant invention. Conventional technologies use one probe and move the sample or the probe to measure multiple sites in a sample. The compact nature of the disclosed invention enables a multiplicity of measurement sites without undue cost or equipment size.

Other features and advantages of this invention will become apparent from the following description read in conjunction with the attached drawings:

### BRIEF DESCRIPTION OF THE DRAWINGS

FIG. 1 is a schematic diagram of one embodiment of the apparatus of this invention.

FIGS. 2a, b, c, d, and e are a detailed schematic diagram of the pump system and figures indicating how the sinusoidal of a tunable frequency is produced.

FIGS. 3a, b, and c show the frequency domain representation of the pump system indicating the effect of the non-linear mixing fiber as the beams are passed through.

FIGS. 4a, b, c and d shows the frequency domain representation of the pump and probe system before a sample and the probe system after the sample.

FIGS. 5a, b, c, d, and e show an illustration of how acoustic resonance in the sample is produced.

FIGS. 6a, b, c, d, and e show an illustration of the sinusoidal pump beam being modulated in order to detect changes in the detected probe beam with higher signal-to-noise ratio using a lock-in amplifier method.

FIG. 7 is an illustration of the lock-in amplifier output when a heterodyned frequency from a pump system is scanned to find the acoustic resonance.

### DETAILED DESCRIPTIONS OF VARIOUS EMBODIMENTS

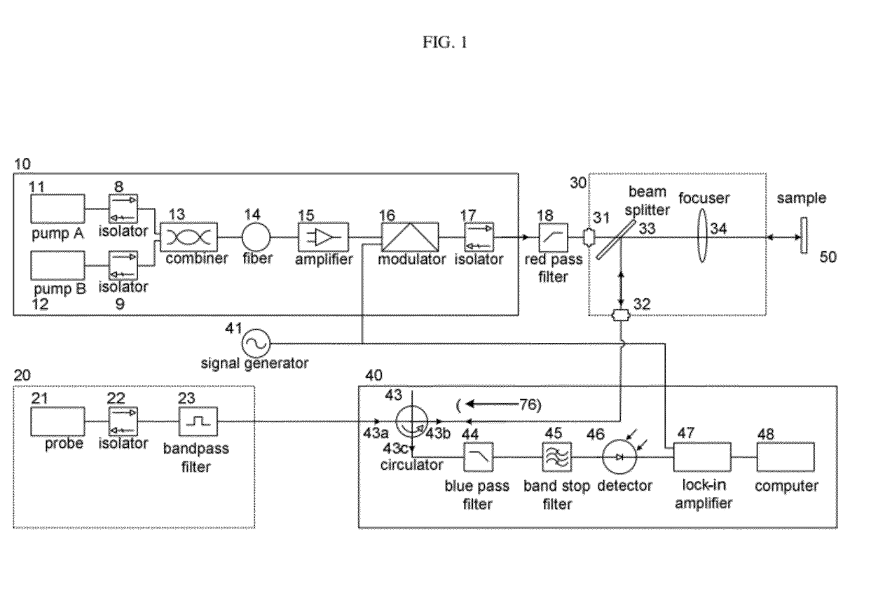

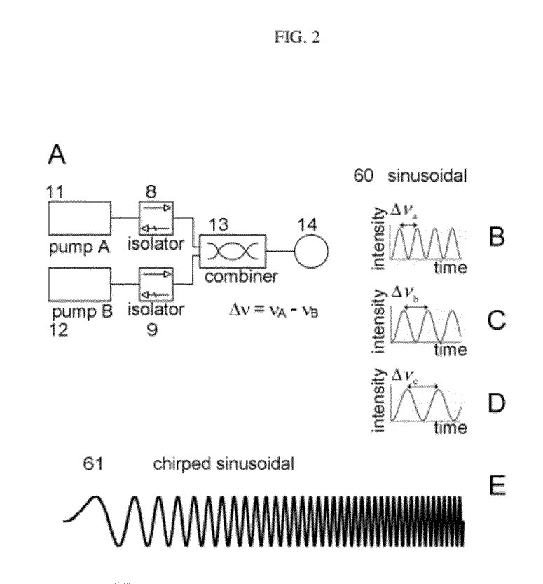

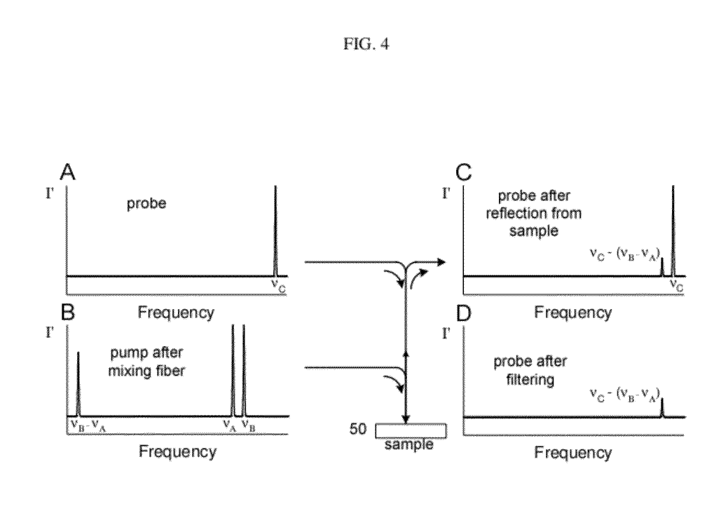

FIG. 1 is a schematic diagram of one embodiment of the apparatus of this invention. The major subsystems include the pump beam system 10, the probe system 20, the focusing optic 30, and the detection system 40. The components enclosed in 10 define the system for the pump beam, which comprises a means for generating an acoustic wave, optionally resonant, in a sample 50 comprising first and second pump beams heterodyned, optionally, in a first optical fiber 14, to produce a periodic waveform with a frequency component between about 10 MHz to about 10 THz. A means for generating an acoustic wave, optionally resonant, comprises 11 and 12, two lasers; in one embodiment the lasers are DFB, distributive fiber grating, cw, continuous wave, lasers of about constant intensity and of different wavelengths; the wavelengths are in a range of about 10 nanometers to about 100 microns. Optionally, a laser wavelength is tuned by a temperature controller and the output light coupled into an optical fiber. Each of the laser beams 11 and 12 are passed through isolators 8 and 9. The isolators keep light going in just one direction, blocking any light going through in the opposite direction because stray light input to the DFB laser changes its characteristics. In order to have the outputs of the two laser beams 11 and 12 in one optical fiber, a combiner 13 is used. The combiner output contains the two original wavelengths in a combined signal; but these wavelengths do not interact with each other in the fiber. The wavelengths can be associated with corresponding frequencies. The combiner output is fed into a non-linear or mixing fiber 14 where the first and second frequencies do interact with each other to create a third frequency. This new component has a frequency Δν that is the difference between the first and second frequencies of the original laser beams 11 and 12. This is further explained in FIGS. 2a, b, c, d and e. The non-linear fiber 14 output is passed through an amplifier 15 in order to increase the power intensity of the new frequency Δν. The first and second frequencies from the laser beams 11 and 12 are also amplified in the process. In one embodiment, the amplifier 15 is an EDFA, erbium-doped fiber amplifier; optionally any amplifier system that increases the intensity will do. The amplified light is passed through a modulator 16 to modulate the intensity in a periodic manner in order to increase the sensitivity of the detection system, which will be explained further in FIGS. 4a, b, c and d. The modulation characteristics are dependent on the input of the signal generator 41. Modulator 16 output light is passed through isolator 17. Again, isolator 17 prevents reflected light originating downstream along the fiber light path from going back towards lasers 11 and 12 and other components upstream of isolator 17.

Red pass filter 18 allows light of wavelength above a cutoff wavelength λ_{red} to pass through in either direction. Light of wavelength below λ_{red} is blocked or redirected away from the rest of the optical system. This is to prevent light from probe system 20 from getting to pump system 10. In one embodiment, pump system 10 has laser light of wavelength longer than probe system 20 thus 18 is a long wavelength, or red, pass filter. In another embodiment, pump system 10 has laser light of wavelength shorter than the probe system 20 and thus 18 is a short wavelength, or blue, pass filter where wavelength longer than λ_{blue} is blocked or redirected away from the rest of the optical system.

A means for combining and focusing the pump and probe beams onto the sample is shown in 30 of FIG. 1, where light from pump system 10 and probe system 20 is combined. In one embodiment, the focusing optic 30 is not fiber based but is a free-space optic, that is, the couplers 31 and 32 have a fiber in one end and collimated light in the other end. This arrangement prevents interaction between light from the pump system and the probe system. In one embodiment, focusing optic 30 is fiber based; there is no interaction between the pump system and the probe system in the fiber where they coexist. The beam splitter 33 is where light from the pump system 10 and the probe system 20 are combined in the path towards the sample 50; also in beam splitter 33 light reflected from the sample 50 is split on its way back through the system. The focuser 34 focuses the now-combined beams to a spot, optionally coincident, which could be from about 0.001 square microns to about 1,000 square microns in area, on the sample 50. In some embodiments means for combining and focusing 30 is located in proximity to sample 50, optionally at a predetermined measurement site; optionally more than one focusing optic 30 may be employed in a manufacturing apparatus to measure one or more measurement sites, simultaneously or not. In an embodiment multiple focusing optics 30 are multiplexed via fiber optic cables to share a common means for generating 10, a means for monitoring 40 and a means 20 for generating a constant intensity probe beam, independent from the pump beam, traveling in a second optical fiber.

The components enclosed in 20 shows an exemplary system for a means for generating a constant intensity probe beam, independent from the pump beam, traveling in a second optical fiber; a probe beam is a means for detecting an acoustic wave in a sample when combined with a means for monitoring a reflected probe beam 40. Means 20 starts with 21, a DFB, distributive fiber grating, cw, continuous wave laser of constant intensity. The laser wavelength may be in the range from about 10 nanometers to about 100 microns. Optionally, a laser wavelength is tuned by a temperature controller and the output light coupled into an optical fiber. The probe output light is passed through the isolator 22. The isolator 22 prevents reflected light originating from further along the fiber light path into going back towards the probe laser. The bandpass filter 23 passes only the probe laser wavelength, within a range width from about 0.01 nm to about 100 nm and centered at the probe laser wavelength. Light outside a predetermined range is redirected away from the optical path whether it travels forward or backward or downstream or upstream.

The components enclosed in 40 define an exemplary detection system for measuring changes in reflectivity of the probe beam from sample 50. In circulator 43, light enters through 43a and exits 43b. Light that enters 43b exits 43c. Circulator 43 redirects reflected light from a sample as it goes back into the fiber system. The probe laser light that goes out 43b goes to the focusing system 30, passing through the coupler 32 and becomes strain wave 72. Upon its return back from the sample, strain wave signal 76 from strain wave 75, enters 43b and exits out 43c, as shown in FIG. 1.

A blue pass filter 44 allows light of wavelength below a cutoff wavelength λ_{blue} to pass through in either direction. Light of wavelength above or longer than λ_{blue} is blocked or redirected away from the rest of the optical system. This is to prevent light from the pump system 10 getting to the detector 46. In one embodiment, probe system 20 has laser light of wavelength shorter than the pump system 10 thus 44 is a blue pass filter. In another embodiment, probe system 20 has laser light of wavelength longer than pump system 10 and thus 44 is a red pass filter wherein wavelength below λ_{red} is blocked or redirected away from the rest of the optical system.

Light from blue pass filter 44 is passed though band stop filter 45. This is to prevent original probe laser light from going to detector 46. After probe laser light is reflected off sample 50, detection of the acoustic wave is through the change in reflectivity of the probe laser light, which will be observed as a small intensity satellite peak near the original probe laser wavelength. This will further be explained in FIG. 4. The band stop filter 45 prevents the original probe laser wavelength but not the satellite peak from reaching detector 46. Band stop filter 45 blocks only probe laser wavelength, to within a range of width about 0.01 nm to about 100 nm and centered at the probe laser wavelength. All light not in the range passes through.

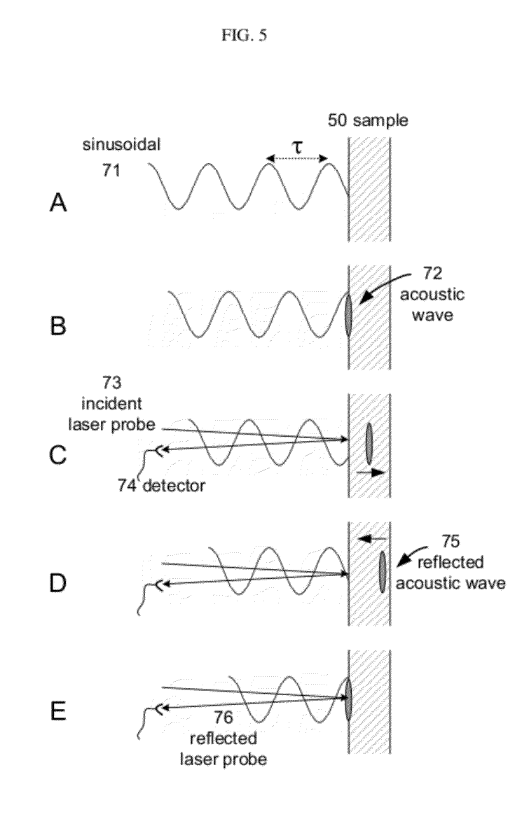

Detection of the satellite peak intensity is through a lock-in method, explained in FIG. 5, hence the use of the signal generator 41 and the lock-in amplifier 47. A data acquisition system, such as a computer, records the satellite peak intensity versus time.

FIG. 2 shows the parts of the pump system 10 involved in producing radiation, or light, with sinusoidal intensity whose frequency is the difference between the first and second frequencies of two pump lasers 11 and 12. Combiner 13 is where the two laser lights are combined to coexist in the same fiber. There is no interaction between them in the combiner 13, however. The fiber 14 is where the two frequencies interact to produce light of a different frequency. In one embodiment, fiber 14 is a non-linear fiber where the interaction is frequency mixing or heterodyning, a well-known phenomenon (Agrawal, Applications of Nonlinear Fiber Optics, Academic Press, 2008 and Chi-Luen Wang; “Tunable multi-terahertz beat signal generation from a two-wavelength laser-diode array”; Optics Letters vol. 20 No. 11, Jun. 1, 1995, 1292.) where one of the output components is a frequency Δν that is the difference between two frequencies from pump lasers 11 and 12. In one embodiment a non-linear medium, not a fiber optic but rather, optionally, a non-linear single crystal, such as KH₂PO₄, KDP, dihydrogen phosphates, including KD₂PO₄; optionally other materials such as cubic zinc sulfide, sphalerite, and its isomorphs including ZnSe, ZnTe, GaAs, and CuCI, and others available from Cleveland Crystals, or non-linear non-single crystal, functions in place of or in front of element 14 as a non-linear medium wherein frequency mixing occurs; not shown in FIG. 2. In some embodiments a difference frequency Δν is changed by controlling one or both of the frequencies of the pump lasers 11 and 12 through each of their temperature controllers. FIG. 2 shows example sinusoidal waveform output from the fiber 14 where the frequency is different in each case.

In one embodiment, fiber 14 is a non-linear fiber whose output includes a sinusoidal waveform whose frequency is the difference between the two input frequencies. In another embodiment, the output is not a sinusoidal waveform but a periodic waveform whose frequency is the difference between the two inputs. In another embodiment, fiber 14 is a system of different, non-linear and linear fibers of varying lengths operable to produce the difference frequency and multiples of it. In one embodiment, the output of fiber 14 is a periodic waveform whose frequency of arrival at the sample is the frequency difference between the two inputs.

In one embodiment of the invention, the difference frequency Δν varies linearly as a function of time. This is the case for a chirped sinusoidal waveform. A chirped waveform is defined herein as a linear change in frequency of a sinusoidal and has the general form

f(t)=A sin(2π(ν₀+αt)) (1)

where A is the amplitude, ν₀ is the initial frequency, and α the rate at which the frequency is changing. A chirped sinusoidal waveform 61 shows one example of how the frequency changes. In another embodiment, a sinusoidal waveform stays at one frequency while measurements are made. After a first series of measurements, the frequency is changed to another value and a second series of measurements are made. The process may be repeated through multiple series of measurements and completed for a range of predetermined frequency values.

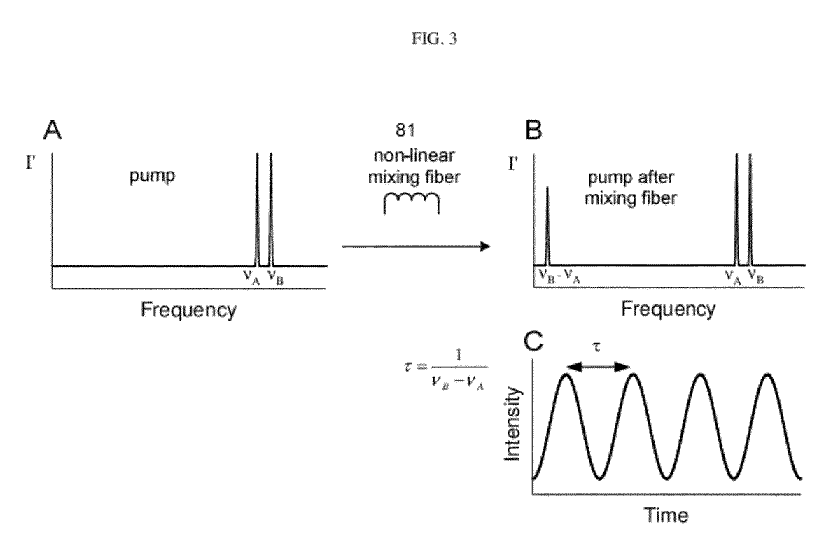

An embodiment in FIG. 3 shows in the frequency domain light from the two pump lasers A and B. Before non-linear mixing fiber 81 there are two narrow lines representing two laser frequencies. After the non-linear mixing fiber 81, the two narrow lines are still there, but there is now a mixed component that is sinusoidal and has a frequency Δν=ν_{B}−ν_{A} that is the difference between the two and could be in a range, optionally, from about 0.1 GHz to about 10 THz. Light or radiation intensity is dependent upon how non-linear a fiber 81 is. The idea of generating new frequencies by mixing (or multiplying) two waveforms is known as heterodyning and is used in radio and signal processing.

FIGS. 4a, b, c and d are in the frequency domain. FIG. 4a shows the probe laser frequency; FIG. 4b is the pump signal after mixing fiber 81. Incident on sample 50 is the waveform from the pump system that passed though the non-linear mixing fiber 81 so that it contains a frequency component Δν=ν_{B}−ν_{A}. Also incident on the sample is the probe laser. Upon reflection from the sample, if the probe laser changes in reflectivity due to the existence of a acoustic wave at the surface, this change in reflectivity is observed as a frequency component, a satellite peak at ν_{C}−(ν_{B}−ν_{A}) close to the probe frequency ν_{C}, as shown in FIG. 4c. Upon filtering the original probe frequency ν_{C}, only the satellite peak ν_{C}−(ν_{B}−ν_{A}) is left for detection, as shown in FIG. 4d.

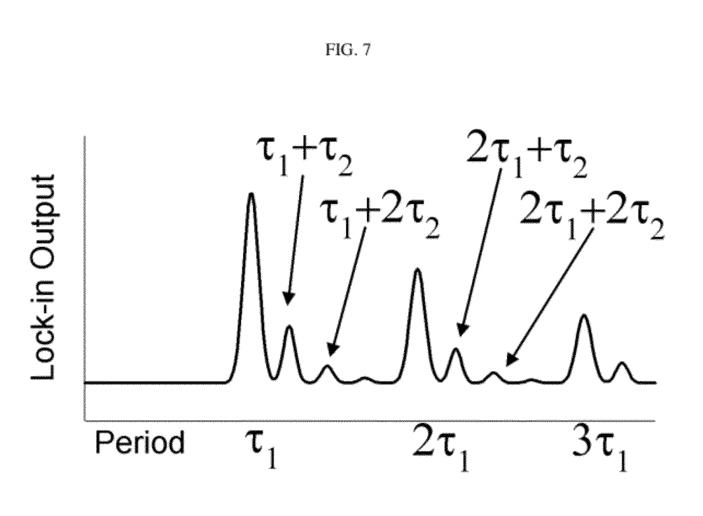

FIGS. 5a, b, c, d and e show the effect of producing and detecting the acoustic wave in the sample. It starts with the periodic sinusoidal pump laser radiation 71 produced from the mixing of the two lasers in the pump system. The periodic sinusoidal pump laser radiation has a period τ and is incident on the sample as shown in FIG. 5a. At a time as shown in FIG. 5b when there is maximum intensity of the sinusoidal pump wave at the surface, there is the greatest amount of energy absorption at the surface. Energy absorption leads to thermal expansion, which leads to generation of an acoustic or strain wave 72 as shown in FIG. 5b. The acoustic wave 72 propagates into the film on sample 50 as shown in FIG. 5c. Simultaneously, there is the continuous and constant intensity laser probe 73 that is also incident at the surface. Laser probe 73 becomes reflected signal 76 as generated by interaction with acoustic wave's 75 arrival back at the surface of 50; signal amplitude of 76 is measured by the detector 74 and determines one or more values of τ₁ and/or τ₂ and combinations thereof as shown in FIG. 7; τ₁ is associated with a single thin film while τ₂ up to τₙ are associated with a second or “n” films. When acoustic wave 72 encounters an interface, some of its energy is reflected back and the rest continues to propagate into the next medium, as shown in FIG. 5d. All this time the laser probe 73/76 reflected signal is continuously being measured. After some time the acoustic wave finally reaches the surface as shown in FIG. 5e. When the arrival of the acoustic wave coincides with the arrival of the next intensity maximum of the sinusoidal laser pulse 71 at some time τ later, then there is energy absorption and thermal expansion again. The thermal expansion adds to the intensity of the acoustic wave. Repeated excitation at just the right time from the periodic maxima leads to a growth of the acoustic wave; resonance occurs. A large acoustic wave intensity at the surface changes the reflected signal of the laser probe 73/76. When the arrival of the acoustic wave 75 does not coincide with the next maximum of the periodic sinusoidal laser pulse 71 then there is no growth of the acoustic wave and there is no resonance—there will be little change in the reflected laser probe signal 73/76.

By scanning a predetermined range of frequencies via a chirped waveform, a resonance occurs when the period τ corresponds to the round trip time of the acoustic wave, which is τ=2T/V where T is the film thickness and V is the acoustic wave velocity. The factor of two is for the round trip from surface to interface and then back. The presence or lack of resonance in the measured signal is a distinguishing feature of the instant invention.

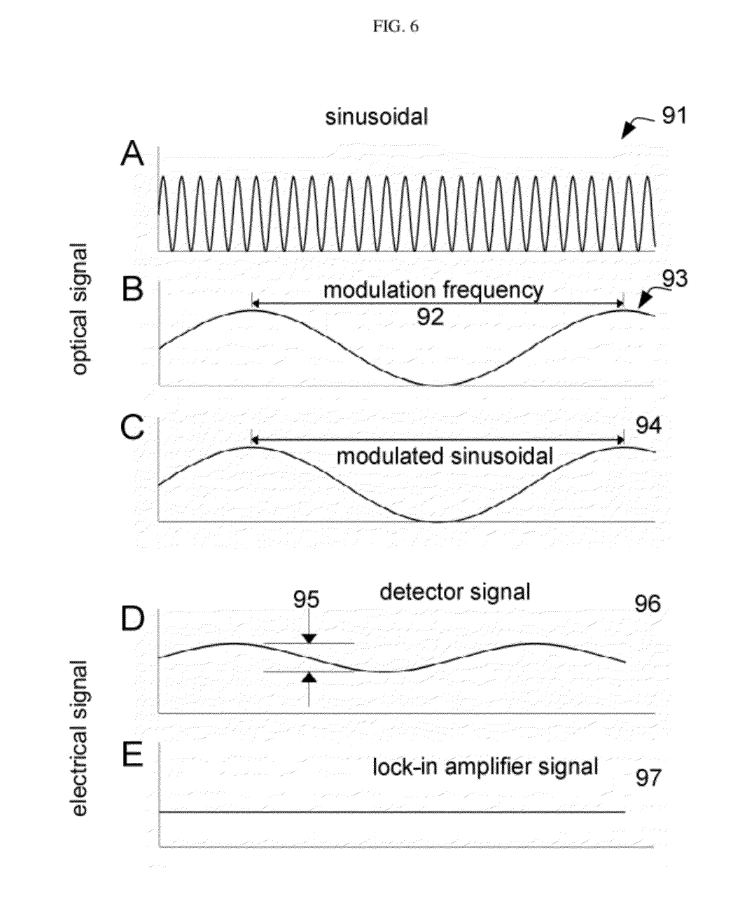

FIGS. 6a, b, c, d and e explain a technique of one embodiment for increasing the signal-to-noise ratio for detecting changes in the laser probe 73 reflectivity. A lock-in amplifier is a well-known technique (Higgins, Electronics with Digital and Analog Integrated Circuits, Prentice-Hall, 1983) for small signal detection. The periodic sinusoid pump signal from the pump system is represented as 91. A reference waveform 93 is also periodic but with a much larger modulation frequency 92 that could be in the range of 1 Hz to 10 MHz, optionally higher. The reference waveform 93 is multiplied with the original waveform 91 to produce a modulated sinusoidal 94 before it impinges into sample. The change in laser probe 73 reflectivity necessarily modulates according to modulation frequency 92. The detected signal 96 of the laser probe reflectivity 73 is shown in FIG. 6d. The lock-in amplifier detection system detects signals that are modulated according to reference frequency 92. Signals that do not have the reference frequency give zero amplitude after the lock-in amplifier, thus decreasing the noise of the detected signal.

FIG. 7 shows the lock-in amplifier output as a function of the sinusoidal period when the film sample has two distinct layers on top of the substrate. τ₁ is the round trip time of the associated acoustic wave 72 going through the top most layer. When the mixed sinusoidal pump waveform from the pump system has a frequency (or period) associated with the round trip time of the acoustic wave, there is a maximum in the lock-in amplifier output. The peak 2τ₁ in FIG. 7 corresponds to an acoustic wave that travelled two round trips in the first layer and the peak 3τ₁ to an acoustic wave that travelled three round trips.

τ₁==2T/V (2)

2τ₁=4T/V (3)

nτ₁=n2T/V (4)

where n is the number of round trips, τ is the sinusoidal period, V is the acoustic velocity, and T is the film thickness.

There are other peaks in FIG. 7 associated with the second film layer where the round trip time of an acoustic wave is τ₂. This allows thickness calculation of the second layer. For a film structure of multiple n layers, the thickness of the n layers can be measured by analyzing the spectrum for the multiple n distinct periods.

The magnitude of the peak in FIG. 7 depends in part on the acoustic reflection coefficient at the interface between the film and the substrate. This reflection coefficient R is defined as

$$R = {( \frac{{Z}_{2} - {Z}_{1}}{{Z}_{2} + {Z}_{1}} )}^{2} \qquad ( 5 )$$

where Z is the acoustic impedance and defined as

Z=ρV (6)

where ρ is the bulk density of the material and V the acoustic velocity. The subscript 2 is for the substrate and 1 for the film.

A series of peaks τ₁, 2τ₁, τ₁+τ₂, τ₁+2τ₂ and 3τ₁ as shown in FIG. 7 correspond to multiple round trips though the top most layer and a second layer, and from the successive decrease in amplitude the reflection coefficient is determined. If the substrate density and substrate acoustic velocity are known and the acoustic impedance for each thin film layer is known or approximated then the velocity associated with transiting film 1 or film 2 or film n can be calculated; correspondingly, the density of a film, 1, 2, . . . n, can be calculated.

$${R}_{n} = {{R}_{n - 1} ( \frac{{Z}_{n} - {Z}_{n - 1}}{{Z}_{n} + {Z}_{n - 1}} )}^{2} \qquad ( 7 )$$

where n represents the nth round trip corresponding to the nth peak in FIG. 7. This equation can be used to solve for the film density given certain assumptions about acoustic impedance; regardless a change in τ signals a change in thin film layer deposition process reproducibility based on the interrelationship of film density and thickness and acoustic impedance.

Yet another parameter than can be calculated is the roughness; this can be calculated according to the width of the peaks in FIG. 7 and using the analysis explained in the reference Thomsen, et al., Phys. Rev. B 34 1989 (4129).

In one embodiment an apparatus for measuring film properties in a sample by a resonant acoustic wave comprises a means for generating an acoustic wave comprising first and second pump beams heterodyned in a non-linear medium to produce a periodic waveform with a frequency component between about 10 MHz to about 10 THz; a means for generating a constant intensity probe beam, independent from the pump beam, traveling in a second optical fiber; means for combining and focusing the pump and probe beams onto the sample such that the probe beam has a reflected probe beam component; and means for monitoring the reflected probe beam component signal amplitude of a frequency component equal to the heterodyned frequency induced by the resonant acoustic wave wherein the round trip time of the resonant acoustic wave, τ, is determined; optionally, the pump and probe beams are generated by a laser; optionally, the pump beams comprise two or more different frequencies and are heterodyned in a non-linear medium chosen from a group consisting of optical fibers, single crystals and non-single crystals; optionally, the acoustic wave generator generates a pump beam with an adjustable frequency, periodic waveform; optionally, the probe beam frequency is different from the frequencies of the pump beam; optionally, the pump and probe beams are coincident at the same spot at the sample; optionally, the pump and probe beam signals, reflect from the sample, and pass through a wavelength selective beam splitter such as a hot/cold mirror; optionally, the reflected probe beam signal is passed through a narrow-band filter, such as a blue pass filter, such that substantially only reflected probe signals are transmitted; optionally, the intensity of the reflected peaks of the probe beam signal are detected and determine one or more film properties chosen from a group consisting of film thickness, film roughness, thermal conductivity, thermal expansion coefficient, volume specific heat and film density.

In one embodiment an apparatus for manufacturing an article comprising one or more measurement sites comprising an apparatus utilizing a resonant acoustic wave operable to measure one or more film properties of the article chosen from a group consisting of film thickness, film roughness and film density; optionally, the apparatus utilizing a resonant acoustic wave measures one or more measurement sites of the article approximately at the same time.

In one embodiment a method for manufacturing an article comprising one or more measurement sites comprises the step; measuring one or more film properties at one or more measurement sites of the article with a means for measuring comprising an acoustic wave generator generating first and second pump beams heterodyned to produce a periodic waveform with a frequency component between about 10 MHz to about 10 THz; a means for generating a constant intensity probe beam, independent from the pump beam, traveling in a second optical fiber; means for combining and focusing the pump and probe beams onto the sample; and means for monitoring the reflected probe beam signal amplitude of a frequency component equal to the heterodyned frequency induced by the resonant acoustic wave wherein the round trip time of the resonant acoustic wave, τ, is determined.

In one embodiment an apparatus for measuring film properties in a sample at a measurement site by a resonant acoustic wave comprising means for generating a resonant acoustic wave, optionally heterodyned; means for generating a probe beam such that it is reflected from the sample measurement site; means for monitoring the amplitude of the probe beam reflected from the sample measurement site such that one or more film properties of the sample chosen from a group consisting of film thickness, film roughness, thermal conductivity, thermal expansion coefficient, volume specific heat and film density is measured.

In the preceding description, numerous specific details are set forth, such as particular structures, components, materials, dimensions, processing steps and techniques, in order to provide a thorough understanding of the present invention. However, it will be appreciated by one of ordinary skill in the art that the invention may be practiced without these specific details. In other instances, well-known structures or processing steps have not been described in detail in order to avoid obscuring the invention.

### REFERENCES

The following publications are incorporated herein in their entirety by reference.

### U.S. PATENTS

U.S. Pat. Nos. 4,513,385; 4,522,510; 4,579,463; 4,634,290; 4,679,946; 4,710,030; 5,206,710; 5,408,327; 5,633,711; 5,706,094; 5,748,317; 5,959,735; 6,016,202; 6,025,918; 6,271,921; 6,812,047.

### PUBLICATIONS

1. A. ROSENCWAIG et al., “Thin-film thickness measurements with thermal waves”. Applied Physics Letters vol. 43 No. 2, Jul. 15, 1983, p. 166-168.
2. A. ROSENCWAIG et al., “Detection of thermal waves through optical reflectance”. Applied Physics Letters vol. 46 No. 11, Jun. 1, 1985, p. 1013.
3. G. EESLEY et al., “Generation and detection of picosecond acoustic pulses in thin metal films”. Applied Physics Letters vol. 50 No. 12, Mar. 23, 1987, p. 717.
4. J. A. ROGERS et al., “Study of Lamb acoustic waveguide modes in unsupported polymide thin films using real-time impulsive stimulated thermal scattering”. Journal of Applied Physics vol. 75 No. 3, Feb. 1 1994, p. 1534.
5. J. A. ROGERS et al., “Optical system for rapid materials characterization with the transient grating technique: Application to nondestructive evaluation of thin films used in microelectronics”. Applied Physics Letters vol. 71 No. 2, Jul. 14, 1997, p. 225.
6. MOHAMMAD AL-MUMIN, Cheolhwan Kim, Inwoong Kim, Nazar Jaafar, Guifang Li, “Injection locked multi-section gain-coupled dual mode DFB laser for terahertz generation”. Optics Communications vol. 275, 2007, p. 186.
7. RICHARD J. HIGGINS, Electronics with Digital and Analog Integrated Circuits, Prentice-Hall 1983, ISBN 0-13-250704-8.
8. C. THOMSEN, J. Strait, Z. Vardeny, H. J. Maris, and J. Tauc, “Coherent Phonon Generation and Detection by Picosecond Light Pulses”. Physical Review Letters vol. 53 No. 10, 3 Sep. 1984, p. 989.
9. C. THOMSEN, H. T. Grahn, H. J. Maris, and J. Tauc, “Surface generation and detection of phonons by picosecond light pulses”. Physical Review B vol. 34, September 1989, p. 4129.
10. R. M. WHITE, “Generation of Elastic Waves by Transient Surface Heating”. Journal of Applied Physics vol. 34 No. 12, p. 3559.
11. GOVIND P. AGRAWAL, Applications of Nonlinear Fiber Optics 2^{nd} edition, Academic Press 2008, ISBN 0123473028.

We claim:

1. An apparatus for measuring film properties in a sample by a resonant acoustic wave comprising:
a means for generating a resonant acoustic wave comprising first and second pump beams heterodyned in a non-linear medium to produce a periodic waveform with a frequency component between about 10 MHz to about 10 THz;
a means for generating a constant intensity probe beam, independent from the pump beam, traveling in a second optical fiber;
means for combining and focusing the pump and probe beams onto the sample such that the probe beam has a reflected probe beam component; and
means for monitoring the reflected probe beam component signal amplitude of a frequency component equal to the heterodyned frequency induced by the resonant acoustic wave wherein the round trip time of the resonant acoustic wave, z, is determined.

2. An apparatus of claim 1 wherein the pump and probe beams are generated by a laser.

3. An apparatus as in claim 2 wherein the pump beams comprise two or more different frequencies and are heterodyned in a non-linear medium chosen from a group consisting of optical fibers, single crystals and non-single crystals.

4. An apparatus of claim 1 wherein the acoustic wave generator generates a pump beam with an adjustable frequency, periodic waveform.

5. An apparatus of claim 1 wherein the probe beam frequency is different from the frequencies of the pump beam.

6. An apparatus of claim 5 wherein the pump and probe beams are coincident at the same spot at the sample.

7. An apparatus of claim 6 wherein the pump and probe beam signals, reflect from the sample, and pass through a wavelength selective beam splitter.

8. An apparatus of claim 7 wherein the reflected probe beam signal is passed through a narrow-band filter such that substantially only reflected probe signals are transmitted.

9. An apparatus of claim 8 wherein the intensity of the reflected peaks of the probe beam signal are detected and determine one or more film properties chosen from a group consisting of film thickness, film roughness, thermal conductivity, thermal expansion coefficient, volume specific heat and film density.

10. An apparatus for manufacturing an article comprising one or more measurement sites comprising an apparatus of claim 1 operable to measure one or more film properties of the article chosen from a group consisting of film thickness, film roughness, thermal conductivity, thermal expansion coefficient, volume specific heat and film density.

11. The apparatus of claim 10 wherein the apparatus of claim 1 measures one or more measurement sites of the article approximately at the same time.

12. A method for manufacturing an article comprising one or more measurement sites comprising the step;
measuring one or more film properties at one or more measurement sites of the article with a means for measuring comprising an acoustic wave generator generating first and second pump beams heterodyned to produce a periodic waveform with a frequency component between about 10 MHz to about 10 THz; a means for generating a constant intensity probe beam, independent from the pump beam, traveling in a second optical fiber; means for combining and focusing the pump and probe beams onto the sample; and means for monitoring the reflected probe beam signal amplitude of a frequency component equal to the heterodyned frequency induced by the resonant acoustic wave wherein the round trip time of the resonant acoustic wave, τ, is determined.

13. An apparatus for measuring film properties in a sample at a measurement site by a resonant acoustic wave comprising:
means for generating a resonant acoustic wave;
means for generating a probe beam such that it is reflected from the sample measurement site;
means for monitoring the amplitude of the probe beam reflected from the sample measurement site such that one or more film properties of the sample chosen from a group consisting of film thickness, film roughness, thermal conductivity, thermal expansion coefficient, volume specific heat and film density is measured.
